(19) United States
(12) Patent Application Publication
(10) Pub. No.: US 2015/0187250 A1
(43) Pub. Date: Jul. 2, 2015

(54) INFORMATION PROCESSING METHOD AND ELECTRONIC DEVICE

(71) Applicant: LENOVO (BEIJING) CO., LTD., Beijing (CN)

(72) Inventor: Cheng CHANG, Beijing (CN)

(21) Appl. No.: 14/464,460

(22) Filed: Aug. 20, 2014

(30) Foreign Application Priority Data
Dec. 30, 2013 (CN) 201310746889.3

(51) Int. Cl. G09G 3/20; G09G 3/36; G06F 3/048; G09G 3/34

(52) U.S. Cl. CPC G09G 3/2003; G09G 3/3413; G09G 3/3607; G06F 3/048; G09G 2360/144; G09G 2320/0666

(57) ABSTRACT

The present application discloses an information processing method and an electronic device. The information processing method is applied to an electronic device, and the electronic device includes a display unit on which an interactive interface is displayed, the method including obtaining an ambient brightness value of an ambient where the display unit is located; determining whether the ambient brightness value is larger than or equal to a preset brightness value; adjusting a first kind of color in the interactive interface to a second kind of color different from the first kind of color when the ambient brightness value is larger than or equal to the preset brightness value, wherein a first reflectivity of a reflected light of the first kind of color is smaller than a second reflectivity of a reflected light of the second kind of color.

### CROSS REFERENCE TO RELATED APPLICATIONS

This application claims the benefit under 35 U.S.C. §119(a) of Chinese Patent Application No. 201310746889.3 filed on Dec. 30, 2013, entire disclosure of which is incorporated herein by reference in its entirety.

### TECHNICAL FIELD

The present disclosure relates to a field of electronic technology, more particularly to an information processing method and an electronic device.

### BACKGROUND ART

With a development of science and technology, electronic technology has progressed rapidly. There are more and more electronic products, and human beings are enjoying the conveniences brought this development. The human beings can now enjoy comfortable lives by using various types of electronic devices. For example, electronic devices such as smart phones, tablet PCs etc. have become an important part in daily life; users may listen to music and play games, etc., to relax from a rapid pace of modern life.

When using an electronic device such as a smart phone, a tablet PC etc. in a bright environment where there is direct sunlight on the display screen of the electronic device, the users will automatically contract their pupils to prevent damage to their eyes by light from the external environment. However, this also prevents some light from the display screen from entering into the users' eyes, thus making the users unable to see the content clearly on the display screen.

Currently in a bright environment, in order to increase the ratio of light emitted by the display screen entering the human eyes, the backlight brightness of the display screen of electronic device is increased. For example, the user may automatically adjust the backlight brightness of the display screen, or, in this case of a mobile phone, the backlight brightness is automatically increased in a bright environment by a light sensor detecting the light intensity of the external environment, so that the user may clearly see the content on the display screen.

Nevertheless, during the implementation of the above technical solutions, the inventor finds that these technologies have at least the following problems:

The prior art uses the technical solution of increasing the backlight brightness of the display of the electronic device so that the user can clearly see the content on the display screen. This results in an increase in the power consumption of the electronic device and the continued use time of the electronic device is thus reduced, and the user's experience is also diminished.

Therefore, the technical solution in the prior art that the backlight brightness of the display screen of the electronic device is increased to make the user clearly see the content on the display screen has the technical problem of making the power consumption of the electronic device high.

### SUMMARY OF THE INVENTION

Embodiments of the present disclosure propose an information processing method and an electronic device, which solve the technical problem whereby the power consumption of an electronic device such as a smart phone, a tablet PC, etc. is high, this technical problem existing in the technical solution in the prior art in which the backlight brightness of the display screen of the electronic device is increased to enable the user to clearly see the content on the display screen.

In one aspect, the embodiments of the present invention provide an information processing method applied to an electronic device, the electronic device including a display unit on which there is an interactive interface, the method including obtaining an ambient brightness value of an ambient where the display unit is located; determining whether the ambient brightness value is larger than or equal to a preset brightness value; adjusting a first kind of color in the interactive interface to a second kind of color different from the first kind of color when the ambient brightness value is larger than or equal to the preset brightness value, wherein a first reflectivity of a reflected light of the first kind of color is smaller than a second reflectivity of a reflected light of the second kind of color.

Optionally, when the display unit is specifically a liquid crystal display (LCD) screen, a first light transmission property of an LCD module of the LCD screen in the case of displaying the first kind of color is smaller than a second light transmission property of the LCD module in the case of displaying the second kind of color.

Optionally, obtaining the ambient brightness value of the ambient where the display unit is located is specifically obtaining the ambient brightness value by a light sensor.

Optionally, before adjusting the first kind of color in the interactive interface to the second kind of color different from the first kind of color, the method further includes determining the first kind of color that needs to be adjusted in the interactive interface.

Optionally, adjusting the first kind of color in the interactive interface to the second kind of color different from the first kind of color includes adjusting the first kind of color to gray or white; or adjusting the first kind of color to the second kind of color opposite to the first kind of color according to an opposite-color table.

In another aspect, the embodiments of the present invention provide an electronic device, including a casing; a display unit, disposed on the casing; a light sensor, disposed on the casing and close to the display unit; a circuit board, disposed in the casing and connected to the display unit and the light sensor; a processor, disposed on the circuit board, for obtaining an ambient brightness value of the ambient where the display unit is located by the light sensor, and determining whether the ambient brightness value is larger than or equal to a preset brightness value, and adjusting a first kind of color within an interactive interface displayed on the display unit to a second kind of color different from the first kind of color when the ambient brightness color is larger than or equal to the preset brightness value, wherein a first reflectivity of a reflected light of the first kind of color is smaller than a second reflectivity of a reflected light of the second kind of color.

Optionally, when the display unit is specifically a liquid crystal display (LCD) screen, a first light transmission property of an LCD module of the LCD screen in the case of displaying the first kind of color is smaller than a second light transmission property of the LCD module in the case of displaying the second kind of color.

Optionally, the processor is specifically for, before adjusting the first kind of color in the interactive interface to the second kind of color different from the first kind of color, determining the first kind of color that needs to be adjusted in the interactive interface.

Optionally, the processor is specifically for adjusting the first kind of color to gray or white; or adjusting the first kind of color to the second kind of color opposite to the first kind of color according to an opposite-color table.

The one or more technical solutions provided in the embodiments of the present invention have at least the following technical effects or advantages:

1. The following technical solutions are used obtaining the ambient brightness value where the display unit is located, determining whether the ambient brightness value is larger than or equal to a preset brightness value, and adjusting the first kind of color in the interactive interface to the second kind of color different from the first kind of color when the ambient brightness value is larger than or equal to the preset brightness value, wherein the first reflectivity of the reflected light of the first kind of color is smaller than the second reflectivity of the reflected light of the second kind of color. In contrast to the prior art, it does not need to enable the user to clearly see the content on the display screen by increasing the backlight brightness of the display screen; rather, it increases the light reflected to the user's eyes by the second reflectivity of the reflected light of the second kind of color. Therefore, it solves the technical problem of making the power consumption of the electronic device high, which is inherent in the technical solution in the prior art in which the backlight brightness of the display screen of the electronic device is increased to enable the user to clearly see the content on the display screen, and it realizes the technical effect of saving the power consumption of the electronic device.

2. When the display unit of the electronic device is specifically an LCD screen, as compared with the first kind of color, the second kind of color can only be formed when the smart phone controls the LCD module of the LCD screen to pass more light; the first light transmission property of the LCD module of the LCD screen in the case of displaying the first kind of color is smaller than the second light transmission property of the LCD module in the case of displaying the second kind of color, so that, when the LCD screen displays the second kind of color, the ability of the LCD module to block the light generated by the backlight unit is diminished. Therefore, the light generated by the backlight unit of the LCD screen and entering into human eyes via the LCD module is increased, so that the user can clearly see the contents on the display screen of the smart phone.

### BRIEF DESCRIPTION OF THE DRAWINGS

FIG. 1 is a flowchart of an information processing method according to an embodiment of the present disclosure;

FIG. 2 is a schematic view of an interactive interface according to an embodiment of the present disclosure;

FIG. 3 is a schematic view of an opposite-color table according to an embodiment of the present disclosure;

FIG. 4 is a functional module diagram of an electronic device according to an embodiment of the present disclosure.

### DETAILED DESCRIPTION OF THE PREFERRED EMBODIMENTS

The embodiments of the present application provide an information processing method and an electronic device to solve a technical problem whereby the power consumption of an electronic device such as the smart phone, tablet PC etc. is high due to the technical solution in the prior art in which the backlight brightness of the display screen of the electronic device is increased to enable the user to clearly see the content on a display screen.

In order to solve the above technical problem, the general concept of the technical solution of the embodiments of the present disclosure is as follows:

The embodiment of the present disclosure provides an information processing method which is applied in an electronic device, and the electronic device includes a display unit on which there is an interactive interface, the method including obtaining an ambient brightness value of an ambient where the display unit is located; determining whether the ambient brightness value is larger than or equal to a preset brightness value; adjusting a first kind of color in the interactive interface to a second kind of color different from the first kind of color when the ambient brightness value is larger than or equal to the preset brightness value, wherein a first reflectivity of a reflected light of the first kind of color is smaller than a second reflectivity of a reflected light of the second kind of color.

It can be seen from the above part that it uses the following technical solution obtaining the ambient brightness value where the display unit is located and determining whether the ambient brightness value is larger than or equal to a preset brightness value, and adjusting the first kind of color in the interactive interface to the second kind of color different from the first kind of color when the ambient brightness value is larger than or equal to the preset brightness value, wherein the first reflectivity of the reflected light of the first kind of color is smaller than the second reflectivity of the reflected light of the second kind of color. In contrast to the prior art, it does not need to enable the user to see the content on the display screen by increasing the backlight brightness of the display screen; rather, it increases the light reflected to the user's eyes by the second reflectivity of the reflected light of the second kind of color. Therefore, it solves the technical problem of making the power consumption of the electronic device high, which is inherent in the technical solution in the prior art in which the backlight brightness of the display screen of the electronic device is increased to enable the user to clearly see the content on the display screen, and it realizes the technical effect of saving the power consumption of the electronic device.

In order to better understand the above technical solution, the following will describe the technical solution in detail by combining the accompanying drawings and the specific embodiments.

The embodiments of the present disclosure provide an information processing method, and the method is applied to an electronic device; the electronic device has a display unit on which there is an interactive interface. In practical application, the electronic device may be a smart phone, a tablet PC, or a laptop. The display unit of the electronic device is a display screen, and it may be an ink screen or an LCD screen, which is not specifically defined.

The next part of the specification will illustrate in detail by taking a smart phone as an example of the electronic device.

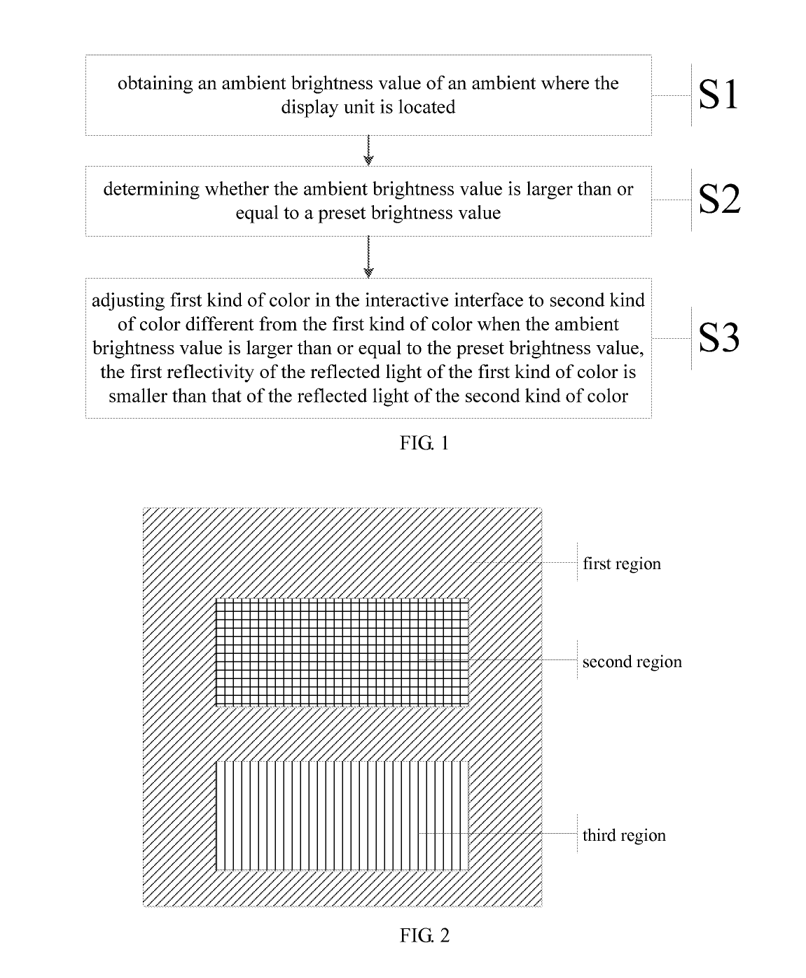

Refer to FIG. 1. FIG. 1 is a flowchart of the information processing method according to an embodiment of the present invention. As shown in FIG. 1, the method includes:

S1: obtaining an ambient brightness value of the ambient where the display unit is located;

S2: determining whether the ambient brightness value is larger than or equal to a preset brightness value;

S3: adjusting a first kind of color in the interactive interface to a second kind of color different from the first kind of color when the ambient brightness value is larger than or equal to the preset brightness value, wherein a first reflectivity of a reflected light of the first kind of color is smaller than a second reflectivity of a reflected light of the second kind of color.

At step S1, obtaining an ambient brightness value of the ambient where the display unit is located, specifically, the ambient brightness value of the ambient where the display unit is located may be obtained by a light sensor.

The light sensor may be composed of a light projector, a light receiver, and a photoelectric sensor. It uses the light projector to focus the light by the lens, and transmits the light to the lens of the light receiver and then to the photoelectric sensor. The photoelectric sensor converts the received light signals into electrical signals, so that the smart phone may obtain the ambient brightness value of the ambient where the display unit is located according to the electrical signal.

A more detailed description is given below, in which the ambient brightness value of the ambient where the display unit is located is taken, as an example, to be 60,000 LX, which is obtained at step S1.

After obtaining the ambient brightness value of the ambient where the display unit is located at step S1, the information process method provided by the embodiments of the present disclosure enters into step S2, i.e., determining whether the ambient brightness value is larger than or equal to the preset brightness value.

In a practical application, the ambient brightness value under direct sunlight in summer at noon is 100,000 LX (Lux), the outdoor ambient brightness value without sunlight is 10,000 to 1,000 LX, and the indoor ambient brightness value in sunny summer weather is 500 to 100 LX; the preset brightness value may be a value under which the user cannot clearly see the content on the display screen of the smart phone. Of course, the process when the user can clearly see the content on the display screen of the smart phone to when the user cannot clearly see the content on the display screen of the smart phone is gradual. Based on the descriptions of the embodiments, those skilled in the art may set the preset brightness value to a proper value according to actual conditions to satisfy a requirement of the actual conditions, which is omitted here. The example below gives a more detailed description in which the preset brightness value is taken to be 50,000 LX.

Of course, in specific implementation, the preset brightness value of the smart phone may be set by those skilled in the art when the smart phone leaves the factory, or set by the user during the use of the smart phone, which is not constrained.

At step 2, it is determined whether the ambient brightness value is larger than or equal to a preset brightness value, i.e. the ambient brightness value obtained at step S1 is compared with the preset brightness value set above; if the ambient brightness value is smaller than the preset brightness value, it means that the user can clearly see the content on the display screen of the smart phone in the current environment; if the ambient brightness value is greater than or equal to the preset brightness value, it means that the user cannot clearly see the content on the display screen of the smart phone in the current environment.

In this embodiment, since the ambient brightness value is 60,000 LX and the preset brightness value is 50,000 LX, the ambient brightness value is larger than the preset brightness value.

In specific implementation, before step S3, the information processing method provided by the embodiments of the present disclosure further includes determining the first kind of color that needs to be adjusted within the interactive interface displayed on the display unit. The first kind of color may refer to color(s) that cannot be seen clearly when the ambient brightness value is larger than or equal to the preset brightness value, i.e. when the display screen of the smart phone is placed in a bright environment under which the brightness value is larger than or equal to the preset brightness value, e.g., black, tea color, red, purple and so on, which are dark colors and have strong light-absorbing capacity. Therefore, little light enters into the user's eyes, so that the user cannot clearly see the content on the display screen of the smart phone.

For example, refer to FIG. 2, which is a schematic view of the interactive interface according to an embodiment of the present disclosure. As shown in FIG. 2, the interactive interface includes 3 regions, wherein the color of the first region is yellow. The RGB (red, green, blue color mode) value of yellow is (255, 242, 0); the color of the second region is red, of which the RGB value is (237, 28, 36); the color of the third region is purple, of which the RGB value is (163, 73, 164). The second region may correspond to an operation key, while the third region may correspond to another operation key.

In this embodiment, a case is described wherein that the color mode is RGB color mode. In practical application, the color mode may be other modes, e.g. CMYK (cyan, magenta, yellow, black) mode or HSB (hue, saturation, brightness) mode, which is not described here.

In practical application, the first kind of color that needs to be adjusted within the interactive interface displayed on the display unit may be determined in two manners as follows:

A first manner:

The first kind of color that needs to be adjusted is marked when the interactive interface is designed, so that when an application corresponding to the interactive interface is in operation, the smart phone may determine the first kind of color that needs to be adjusted within the interactive interface by the markup information in the interactive interface.

For example, refer to FIG. 21. When the interactive interface is designed, the red in the second region and the purple in the third region may be marked as the first kind of color, i.e. the colors that cannot be clearly seen when the ambient brightness value is larger than or equal to the preset brightness value, that is, the display screen of the smart phone is placed in a bright environment under which the brightness value is larger than or equal to the preset brightness value. The operating system of the smart phone may determine that the colors in the second region and in the third region are the first kind of colors that need to be adjusted according to the markup information.

By introduction of this embodiment, those skilled in the art may mark other colors that need to be adjusted in the interactive interface according to actual conditions to meet actual requirements, rather than being limited to the colors listed in this embodiment, which is omitted here.

Of course, the second kind of color to which the first kind of color should be adjusted can be marked also, e.g. red in the second region may be adjusted to aquamarine, whose RGB value is (18, 227, 219); purples may be adjusted to grass green, whose RGB value is (92, 182, 81), so as to be used by the operating system of the smart phone in the subsequent adjustment process, which is omitted here.

A second manner:

When the application corresponding to the interactive interface is in operation, the operating system of the smart phone may obtain color information directly from the interactive interface, by references to a pre-stored first kind of color table. In practical application, the colors that can be clearly seen when the ambient brightness value is larger than or equal to the preset brightness value (that is, when the display screen of the smart phone is placed in a bright environment under which the brightness value is larger than or equal to the preset brightness value) are stored in the first kind of color table, so as to determine which colors in the interactive interface belong to the first kind of color and needs to be adjusted according to the enquiry result.

In this embodiment is a description of the technical solution in the embodiment of the present disclosure by taking as an example red in the second region and purple in the third region being in the pre-stored first kind of color table.

Based on the introduction of this embodiment, those skilled in the art may store proper colors in the first kind of color table according to the actual condition, to satisfy actual requirements.

The above part introduces the detailed process in two manners to determine the first kind of color that needs to be adjusted in the interactive interface displayed on the display unit. Those skilled in the art may, according to the introduction of this part, select other appropriate manners to determine the first kind of color that needs to be adjusted in the interactive interface displayed on the display unit to satisfy actual requirements, which is omitted here.

It needs to be noted that, in practical application, the step of “determining the first kind of color that needs to be adjusted in the interactive interface displayed on the display unit” does not need to be executed every time the first kind of color in the interactive interface is adjusted to the second kind of color different from the first kind of color according to the ambient brightness value. For example, taking determining the first kind of color that needs to be adjusted in the interactive interface displayed on the display unit by the aforementioned first manner as an example, when the application corresponding to the interactive interface is in operation, the smart phone executes the step of “determining the first kind of color that needs to be adjusted according to the markup information of the interactive interface” only once, and it does not need to be confirmed again when the ambient brightness value changes.

In additional, the step of “determining the first kind of color that needs to be adjusted in the interactive interface displayed on the display unit” may be implemented before step S3, and is not ordering with step S1 and step S2. Those skilled in the art may set the order according to actual condition to satisfy actual requirements, which is omitted here.

When it is determined that the ambient brightness value is greater than or equal to the preset brightness value by step S2, the information processing method provided by the embodiment of the present disclosure enters into step 3, i.e. adjusting the first kind of color in the interactive interface to the second kind of color different from the first kind of color.

In specific implementation, adjusting the first kind of color in the interactive interface to the second kind of color different from the first kind of color may specifically include the following two manners:

A first manner: adjusting the first kind of color to gray or white.

Refer to FIG. 2. In the interactive interface as shown in FIG. 2, the red in the second region and the purple in the third region are the first kind of color that needs to be adjusted, so the red in the second region and the purple in the third region are adjusted to gray or white.

It can be seen from this embodiment that a solution is adopted in which the red in the second region and the purple in the third region within the interactive interface on the display screen are changed to gray or white. Before colors are changed, the second region can only reflect a red light and the third region can only reflect a purple light. After the red in the second region and the purple in the third region are changed to gray or white, the second region and the third region on the display screen may reflect a large part of the light. Therefore, as compared with the condition before the colors are changed, the light reflected by the second region and the third region increases, so that the light entering into human eyes also increases and the user can clearly see the content displayed on the display screen of the smart phone.

Further, when the display screen of the smart phone is specifically an LCD screen, since the solution is adopted in which the red in the second region and the purple in the third region are changed to gray or white, as compared with the first kind of color of red and purple, the gray and the white can only be formed when the smart phone controls an LCD module of the LCD screen to pass more light. That is, the first light transmission property of the LCD module when the LCD screen displays the first kind of color is smaller than the second light transmission property of the LCD module when the LCD screen displays the second kind of color. When the LCD screen displays the second kind of color, the ability of the LCD module to block the light generated by the backlight unit is diminished, so that the light generated by the backlight unit of the LCD screen and entering into human eyes by the LCD module is increased, and the user can clearly see the contents displayed on the display screen of the smart phone.

The second manner: adjusting the first kind of color to the second kind of color opposite to the first kind of color according to an opposite-color table.

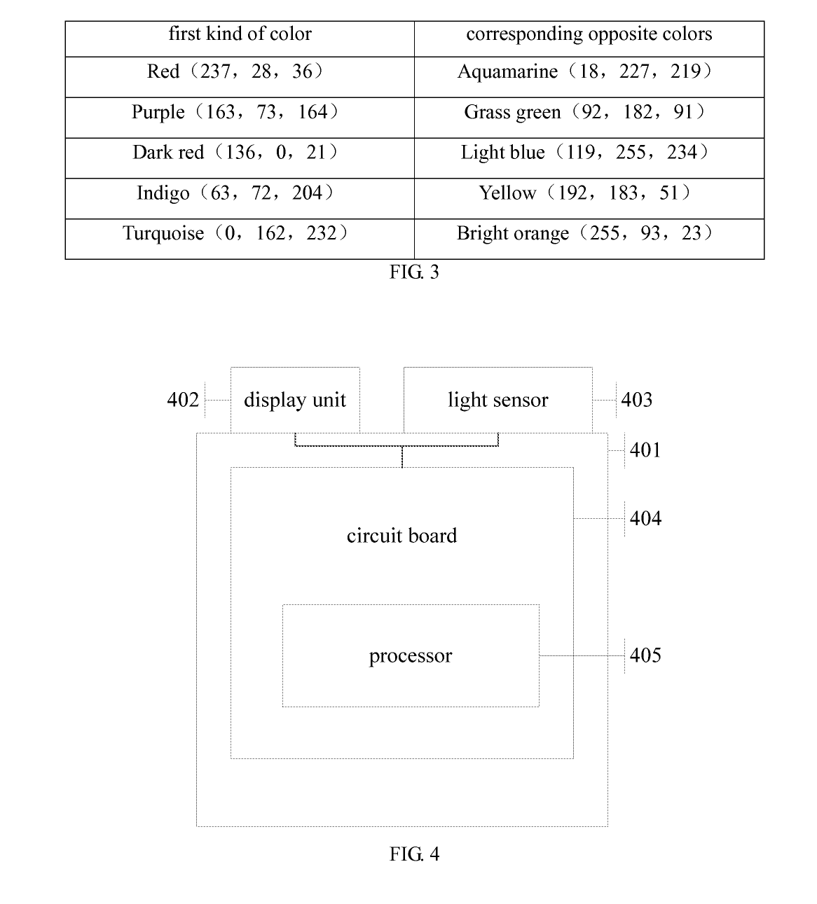

Refer to FIG. 3, which is a schematic view of the opposite-color table provided by the embodiment of the present disclosure. As shown in FIG. 3, the RGB value of the red is (237, 28, 36), and the opposite color of the red is aquamarine, whose RGB value is (18, 227, 219); the RGB value of the purple is (163, 73, 164), and its opposite color is grass green, whose RGB value is (92, 182, 91).

After the first kind of color is adjusted to the second kind of color opposite to the first kind of color according to the opposite-color table, similar to the principle of the first manner, the light in the first kind of color on the display screen of the smart phone which is reflected into human eyes increases, so that the light entering into human eyes increases, and the user can clearly see the contents displayed on the display screen of the smart phone.

As shown in FIG. 3, the first kind of color may further include dark red, indigo, and turquoise. Of course, in practical application, those skilled in the art may determine other first kind of colors that need to be adjusted according to the practical conditions, and determine their corresponding opposite colors, which is omitted here.

Further, when the display screen is specifically an LCD display screen, as compared with the first kind of color, the second kind of color can only be formed when the smart phone controls the LCD module of the LCD screen to pass more light, i.e. the first light transmission property of the LCD module when the LCD screen displays the first kind of color is smaller than the second light transmission property when the LCD screen displays the second kind of color. When the LCD screen displays the second kind of color, the ability of the LCD module to block the light generated by the backlight unit is diminished, so that the light generated by the backlight unit of the LCD screen which enters into human eyes is increased and the user can clearly see the contents displayed on the display screen of the smart phone.

By the introduction of this embodiment, those skilled in the art may change the colors in the user interface that need to be adjusted by other appropriate manners according to actual conditions, so that the user can clearly see the contents displayed on the display screen of the smart phone, which is omitted.

Based on the same inventive concept, the embodiment of the present disclosure also provides an electronic device. In practical application, the electronic device may be a smart phone, a tablet PC, or a laptop, and here it is not specifically restricted.

Refer to FIG. 4, which is a functional module diagram of the electronic device provided by the embodiment of the present disclosure. As show in FIG. 4, the electronic device includes a casing 401; a display unit 402, disposed on the casing 401, the display unit 402 may be an E-ink screen, or an LCD screen in practical application, which is not specifically limited here; a light sensor 403, disposed on the casing 401 and adjacent to display unit 402; a circuit board 404, disposed within the casing 401, and connected to the display unit 402 and the light sensor 403; a processor 405, disposed on the circuit board 404, for obtaining an ambient brightness value of the ambient where display unit 402 is located by light sensor 403, and determining whether the ambient brightness value is larger than or equal to a preset brightness value, and adjusting a first kind of color within an interactive interface displayed on the display unit 402 to a second kind of color different from the first kind of color when the ambient brightness value is larger than or equal to the preset brightness value, wherein a first reflectivity of a reflected light of the first kind of color is smaller than a second reflectivity of a reflected light of the second kind of color.

In specific implementation, when the display unit 402 is specifically an LCD screen, a first light transmission property of the LCD module of the LCD screen in the case of displaying the first kind of color is smaller than a second light transmission property of the LCD module in the case of displaying the second kind of color.

In specific implementation, the processor 405 is for, before adjusting the first kind of color in the interactive interface to the second kind of color different from the first kind of color, determining the first kind of color in the interactive interface that needs to be adjusted.

In specific implementation, the processor 405 is for adjusting the first kind of color to gray or white, or adjusting the first kind of color to the second kind of color opposite to the first kind of color according to an opposite-color table.

The electronic device in this embodiment and the information processing method in the previous embodiment are two aspects of the same inventive concept, and the previous contents have described in detail the implementation of the method. Therefore, those skilled in the art may understand the structure and implementing process of the electronic device in this embodiment according to the previous description and, for clarity, it is omitted here.

The technical solutions in the embodiment of the present application have at least technical effects or advantages as follows:

1. The ambient brightness value of the ambient where the display unit is located is obtained, and it is determined whether the ambient brightness value is larger than or equal to a preset brightness value, and the first kind of color in the interactive interface is adjusted to the second kind of color different from the first kind of color when the ambient brightness value is larger than or equal to the preset value, wherein the first reflectivity of the reflected light of the first kind of color is smaller than the second reflectivity of the reflected light of the second kind of color. As compared with the prior art, it is not necessary to increase the backlight brightness of the display screen to enable the user to clearly see the contents on the display screen; rather, it increases the light reflected to human eyes by the second reflectivity of the reflected light of the second kind of color. Therefore, the technical problem of making the power consumption of the electronic device such as the smart phone, tablet PC etc. high is solved, which is brought about by the technical solution in the prior art whereby the backlight brightness of the display screen of the electronic device such as smart phone, tablet PC, etc. is increased to enable the user to clearly see the contents on the display screen, and the technical effect of saving the power consumption of the electronic device such as smart phone, tablet PC, etc. is realized.

2. When the display unit of the electronic device is the LCD screen, as compared with the first kind of color, the second kind of color can only be formed when the smart phone controls the LCD module of the LCD screen to pass more light. The first transmission property when the LCD screen displays the first kind of color is smaller than the second transmission property when the LCD screen displays the second kind of color. Thus, when the LCD screen displays the second kind of color, the ability of the LCD module to block the light generated by the backlight unit is diminished, that the light generated by the backlight unit of the LCD screen and entering into human eyes via the LCD module is increased, and the user can clearly see the contents displayed on the display screen of the smart phone.

As will be appreciated by one skilled in the art, the embodiments of the present disclosure may be embodied as a method, a system, or a computer program product. Accordingly, the present application may take the form of an entirely hardware embodiment, an entirely software embodiment or an embodiment combining software and hardware. Furthermore, the present disclosure may take the form of a computer program product embodied in one or more computer readable medium(s) having computer readable program code embodied thereon, including but not limited magnetic disk memory, CD-ROM, and optical memory.

The present disclosure is described with reference to a flowchart and/or block diagrams of methods, apparatus (systems) and computer program products according to embodiments of the present application. It will be understood that each flow of the flowchart and/or each block of the block diagrams and combinations of flows of the flowchart and/or blocks in the block diagrams can be implemented by computer program instructions. These computer program instructions may be provided to a processor of a general purpose computer, special purpose computer, embedded processing device or other programmable data processing apparatus to produce a machine, such that the instructions, which are executed via the processor of the computer or other programmable data processing apparatus, create means for implementing the functions specified in the flow(s) of the flowchart and/or the block(s) of the block diagrams.

These computer program instructions may also be stored in a computer readable medium that can direct a computer or other programmable data processing apparatus to function in a particular manner, such that the instructions that are stored in the computer readable medium to produce an article, including instructing manufacture, which implement the functions specified in the flow(s) of the flowchart and/or the block(s) of the block diagrams.

The computer program instructions may also be loaded onto a computer or other programmable data processing apparatus to cause a series of operational steps to be performed on the computer or other programmable apparatus to produce a computer implemented process, such that the instructions which are executed on the computer or other programmable apparatus provide processes for implementing the functions specified in the flow(s) of the flowchart and/or the block(s) of the block diagrams.

Specifically, the computer program instruction corresponding to the information processing method in the embodiment of the present application may be stored in storage mediums such as optical disk, hard disk, USB disk, and so on; when the computer program in the storage medium corresponding to the information processing method is read or executed by an electronic device, it includes the following steps obtaining an ambient brightness value of an ambient where a display unit is located; determining whether the ambient brightness value is larger than or equal to a preset brightness value; adjusting a first kind of color in the interactive interface to a second kind of color different from the first kind of color when the ambient brightness value is greater than or equal to the preset brightness value, wherein a first reflectivity of a reflected light of the first kind of color is smaller than a second reflectivity of a reflected light of the second kind of color.

Further, when the computer program instruction in the storage medium corresponding to the information processing method is read or executed by an electronic device, and when the display unit is specifically an LCD screen, a first transmission property of the LCD module of the LCD screen in the case of displaying the first kind of color is smaller than a second transmission property in the case of displaying the second kind of color.

Further, when the computer program instruction in the storage medium corresponding to the information processing method is read or executed by an electronic device, obtaining the ambient brightness value of the ambient where the display unit is located is specifically obtaining the ambient brightness value by a light sensor.

Further, when the computer program instruction in the storage medium corresponding to the information processing method is read or executed by an electronic device, before adjusting the first kind of color in the interactive interface to the second kind of color different from the first kind of color, the method further includes determining the first kind of color that needs to be adjusted in the interactive interface.

Further, when the computer program instruction in the storage medium corresponding to the information processing method is read or executed by an electronic device, adjusting the first kind of color in the interactive interface to the second kind of color different from the first kind of color includes specifically adjusting the first kind of color to gray or white; or adjusting the first kind of color to the second kind of color opposite to the first kind of color according to an opposite-color table.

Obviously, those skilled in the art may make various changes and modifications to the present application without departing from the spirit and scope of the disclosure. If the changes and modifications of the present disclosure are within the scope of the claims and their equivalent technologies, then the present disclosure also is intended to include the changes and modifications.

1. An information processing method applied to an electronic device, said electronic device comprising a display unit on which an interactive interface is displayed, said method comprising:
obtaining an ambient brightness value of an ambient where the display unit is located;
determining whether said ambient brightness value is larger than or equal to a preset brightness value; and
adjusting a first kind of color in the interactive interface to a second kind of color different from the first kind of color when the ambient brightness value is larger than or equal to the preset brightness value, wherein a first reflectivity of a reflected light of the first kind of color is smaller than a second reflectivity of a reflected light of the second kind of color.

2. The method of claim 1, wherein when said display unit is a liquid crystal display (LCD) screen, a first light transmission property of a LCD module of said LCD screen in the case of displaying said first kind of color is smaller than a second light transmission property of the LCD module in the case of displaying said second kind of color.

3. The method of claim 1, wherein said obtaining the ambient brightness value of the ambient where said display unit is located comprises obtaining said ambient brightness value by a light sensor.

4. The method of claim 1, wherein before the adjusting the first kind of color in said interactive interface to said second kind of color different from the first kind of color, said method further comprising determining said first kind of color that need to be adjusted in said interactive interface.

5. The method of claim 1, wherein said adjusting the first kind of color in said interactive interface to said second kind of color different from the first kind of color comprises:
adjusting said first kind of color to gray or white; or
adjusting said first kind of color to said second kind of color opposite to said first kind of color according to an opposite-color table.

6. An electronic device, comprising:
a casing;
a display unit disposed on said casing;
a light sensor disposed on said casing and close to said display unit;
a circuit board disposed in said casing and connected to said display unit and said light sensor; and
a processor, disposed on said circuit board, for obtaining an ambient brightness value of an ambient where said display unit is located by the light sensor, and determining whether said ambient brightness value is larger than or equal to a preset brightness value, and adjusting a first kind of color in an interactive interface displayed on said display unit to a second kind of color different from said first kind of color when said ambient brightness value is larger than or equal to said preset brightness value, wherein a first reflectivity of a reflected light of said first kind of color is smaller than a second reflectivity of a reflected light of said second kind of color.

7. The electronic device of claim 6, wherein when said display unit is a liquid crystal display (LCD) screen, a first light transmission property of a LCD module of said LCD screen in the case of displaying said first kind of color is smaller than a second light transmission property in the case of displaying said second kind of color.

8. The electronic device of claim 6, wherein said processor is for, before said adjusting the first kind of color in said interactive interface to the second kind of color different from said first kind of color, determining said first kind of color that need to be adjusted in said interactive interface.

9. The electronic device of claim 6, wherein said processor is for adjusting said first kind of color to gray or white; or adjusting said first kind of color to said second kind of color opposite to said first kind of color according to an opposite-color table.

10. An information processing method applied to an electronic device, the electronic device having a display unit on which an interactive interface is displayed, comprising:
obtaining an ambient brightness value of a display ambience where the display unit is located;
determining if the ambient brightness value is larger than or equal to a predetermined brightness value; and
adjusting a first color type in the interactive interface to a second color type when the ambient brightness value is larger than or equal to the predetermined brightness value, the second color type being different from the first color type, the first color type having a first reflectivity of a first reflected light, the second color type having a second reflectivity of a second reflected light, the first reflectivity of the first reflected light in the first color type being a smaller value than the second reflectivity of the second reflected light in the second color type.
